(19) United States
(12) Patent Application Publication
(10) Pub. No.: US 2011/0148279 A1
(43) Pub. Date: Jun. 23, 2011

(54) WHITE LED PHOSPHOR FILM AND ITS MANUFACTURING METHOD

(76) Inventors: Bingqian Li, Shenzhen (CN); Hongcun Peng, Shenzhen (CN); Weiguo Wang, Shenzhen (CN)

(21) Appl. No.: 12/942,027

(22) Filed: Nov. 9, 2010

(30) Foreign Application Priority Data
Dec. 21, 2009 (CN) 200910214025.0

(51) Int. Cl. H01J 1/62; B05D 5/06; B05D 3/10; B29D 11/00; B05D 3/06

(52) U.S. Cl. 313/483; 427/64; 427/534; 427/10; 264/1.1; 427/558

(57) ABSTRACT

A white LED phosphor film is provided. The white LED phosphor film includes a transparent phosphor carrier, and an LED phosphor layer. The LED phosphor layer is manufactured on the phosphor carrier by screen printing process. A method of manufacturing the white LED phosphor film is also provided.

### BACKGROUND OF THE INVENTION

a) Field of the Invention

This invention relates to a white LED phosphor film and its manufacturing method which falls into the semiconductor lighting field.

b) Description of the Prior Art

Conventional white LED lamp usually consists of blue LED chips and phosphor layer which are packaged in a closed space to emit white LED by current technology.

The disadvantages of the above structure are: when phosphor is directly applied on blue LED chip, uniformity of phosphor is difficult to control which results in poor uniform lightness of white LED, and colour temperature of white LED lamp is difficult to adjust after manufactured. The LED chip directly contacts phosphor, thus heat produced by LED chip makes operation temperature over-high, which accelerate phosphor aging and affect the life of white LED lamp.

Application for a patent of invention with publication number CN101017814A involves a white LED lamp with isolated phosphor film. The manufacturing method is as follows: make a phosphor film in advance, install the phosphor film at a proper distance on the front of luminous surface of an LED chip, and finally package the phosphor film and the LED chip in a closed space to produce the white LED lamp with isolated phosphor film. During application for a patent of invention with publication number CN101017814A, a white LED lamp and its manufacturing method is published, wherein a cool colour LED light source and an euphotic layer are sealed in a closed spacing, and a transparent carrier disposed with phosphor layer is set on a lamp housing in front of the euphotic layer to produce white LED.

The published phosphor and LED chip of white LED lamp in CN101017814A and CN101294662A are not closely contacted, thus heat interaction between the two parts is reduced to some extent, which prolongs the life of white LED lamp. However, the published white LED lamp in CN101017814A and CN101294662A does not involve manufacturing method of phosphor layer. Actually it is very difficult to manufacture white LED phosphor film of high transfer efficiency and uniform thickness, and this is why the two light sources motioned above have good advantages, but they are unable to enter market now.

### SUMMARY OF THE INVENTION

The first object of this invention aims to provide a white LED phosphor film.

The second object aims to provide a manufacturing method of white LED phosphor film.

In order to accomplish the first object, a white LED phosphor film is provided in this invention. The white LED phosphor film includes a transparent phosphor carrier, and an LED phosphor layer. The LED phosphor layer is manufactured on the phosphor carrier by screen printing process.

In order to accomplish the second object, a method of manufacturing a white LED phosphor film is provided in this invention. The method of manufacturing a white LED phosphor film includes steps of: preparing a screen plate corresponding to desired viscosity of phosphor paste and thickness of phosphor film; cleaning a transparent phosphor carrier; making phosphor paste with LED phosphor and transparent glue material; printing phosphor paste uniformly on the phosphor carrier via manufactured screen plate; and hardening the phosphor paste to integrate the phosphor carrier with the phosphor paste, thereby forming a phosphor layer on the phosphor carrier.

Preferably, a step of molding the phosphor carrier to a desired shape, before the step of printing the phosphor paste, or after the step of hardening the phosphor paste is included.

According to a preferred embodiment of the present invention, the step of hardening the phosphor paste is carried out by illuminating the phosphor carrier by the ultraviolet hardening light, or baking the phosphor carrier under a predetermined temperature.

Beneficial effects of this invention are as follows: white LED phosphor film manufactured by the above method is of uniform thickness. The ratio of the phosphor to transparent glue material can be accurately controlled to manufacture phosphor films having various color temperature. The phosphor films can be widely applied for various LED lighting sources including LED daylight lamp, LED spotlight, street light, LED tunnel light, and LED light source module. These LED light sources using the phosphor films of this invention have uniform luminance, high transfer efficiency and high reliability.

This invention is described in detail through optimized cases shown in following FIGURE.

### BRIEF DESCRIPTION OF THE DRAWINGS

The present invention will be apparent to those skilled in the art by reading the following description when taken in conjunction with the accompanying drawings, in which:

FIG. 1 shows a schematic diagram of an white LED phosphor film according to an embodiment of the invention.

### DETAILED DESCRIPTION OF THE PREFERRED EMBODIMENTS

The invention is described below in further detail in conjunction with the accompanying drawing and embodiments of the invention.

### Embodiment 1

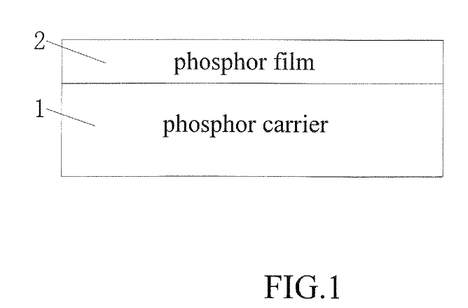

As shown in FIG. 1, a white LED phosphor film of this invention includes phosphor carrier 1 and LED phosphor layer 2. The phosphor carrier 1 is made of transparent material such as Acryl, PC, plastic or glass. The thickness of the phosphor carrier 1 can be chosen as desired in a range from 10 micron to 10 cm. The molding phosphor carrier 1 is of membraneous or slaty shape. The phosphor carrier 1 is covered by phosphor layer 2, whose thickness is 1 micron to 10 mm. The phosphor layer 2 can be thin as 1 micron, and thick as 10 mm, or made with a desired thickness by controlled optimized technology. The phosphor layer 2 includes LED phosphor and transparent glue materials.

Manufacturing method of white LED phosphor film of this invention is introduced as following:

Step A. According to the shape of light source, 150 meshes screen plate is designed and manufactured by mesh of 48 micron diameter. Specification of screen plate is about 50-800 meshes, from which a specific value is chosen according to desired viscosity of phosphor paste and thickness of phosphor film.

Step B. Use alcohol to carry out ultrasound cleaning to the phosphor carrier 1 for 5 minutes to remove impurity on glass surface. Then use pure water to carry out ultrasound cleaning glass for 5 minutes, and dry it for use. In this step, alcohol can be replaced by organic solvent such as acetone. The cleaning time using organic solvent can be 1 second to 10 hours, from which a specific time value is chosen according to actual condition. In this step, plasma cleaning method also can be used.

Step C. Mix purple light-stimulated LED phosphor with transparent epoxy A glue and transparent expoxy B glue according to a weight ratio of 0.1:1.0:1.0, stir them for above 30 minutes to get uniformly mixed phosphor paste, and then vacuum the phosphor paste. In this step, weight ratio of the LED phosphor and the transparent glue is 0.01:1 to 100:1,

Step D. Print phosphor paste uniformly on the phosphor carrier 1 via manufactured screen plate, adopting appropriate screen printing parameters, such as pressure, amount of off-net, and angle of scraper.

Step E. Bake the phosphor carrier 1 under a temperature of 120° C. to harden the phosphor paste. Therefore, the phosphor carrier 1 is integrated with the phosphor paste, forming a phosphor layer 2 on the phosphor carrier 1. In this way, the white LED phosphor film used by white LED light source is produced.

Among the foregoing manufacturing methods, the materials of the phosphor carrier 1 could also be acrylic resin, PC or plastic. These materials are in the forms of film or plate, and the thickness is 10 micro meters to 10 centimeters. Before the above-mentioned step C or after the above-mentioned Step E, a step of molding the phosphor carrier to a desired shape should be carried out.

### Embodiment 2

Step (A). Use 32 micro meters-diameter meshes to design and manufacture 300 meshes of screen plate according to shape of the light source.

Step (B). Use organic alcohol solvent to carry out ultrasonic washing to the phosphor carrier 1 for 5 minutes, so as to wipe off contaminations and foreign substances on the surface of the phosphor carrier 1.

Step (C). Use pure water to carry out ultrasonic washing to the phosphor carrier 1 for 5 minutes. After that, dry it for use.

Step (D). Mix the blue light-stimulated rare earths LED phosphor and UV (ultraviolet) hardening glue (JZ-100) according to a weight ratio of 0.1:1.0. Stir them for over 30 minutes until these two materials become uniformly mixed phosphor paste. Vacuum degassing should be carried out to the phosphor paste.

Step (E). Print phosphor paste uniformly on the phosphor carrier 1 via manufactured screen plate, adopting appropriate screen printing parameters, such as pressure, amount of off-net, and angle of scraper.

Step (F). Illuminate the phosphor carrier 1 which was painted with phosphor paste by an ultraviolet hardening light to carry out ultraviolet hardening. Therefore, the phosphor carrier 1 is integrated with the phosphor paste, forming a phosphor layer 2 on the phosphor carrier 1. In this way, the white LED phosphor film used by white LED light source is produced.

White LED phosphor film manufactured by the above methods is of uniform thickness. The ratio of the phosphor to transparent glue material can be accurately controlled to manufacture phosphor films having various color temperatures. The phosphor films can be widely applied for various LED lighting sources including LED daylight lamp, LED spotlight, street light, LED tunnel light, and LED light source module. These LED light sources using the phosphor films of this invention have uniform luminance, high transfer efficiency and high reliability.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

I claim:

1. A white LED phosphor film comprising a transparent phosphor carrier, and an LED phosphor layer manufactured on the phosphor carrier by screen printing process.

2. The white LED phosphor film according to claim 1, wherein the phosphor layer is made of LED phosphor and transparent glue material, and is 1 micron to 10 mm thick.

3. The white LED phosphor film according to claim 1, wherein the phosphor carrier can be made of Acryl, PC, plastic or glass material, and it is 10 micron to 10 cm thick.

4. The white LED phosphor film according to claim 1, wherein the phosphor carrier can be made of membraneous or slaty material.

5. A method of manufacturing a white LED phosphor film, comprising steps of:
preparing a screen plate corresponding to desired viscosity of phosphor paste and thickness of phosphor film;
cleaning a transparent phosphor carrier;
making phosphor paste with LED phosphor and transparent glue material;
printing phosphor paste uniformly on the phosphor carrier via manufactured screen plate; and
hardening the phosphor paste to integrate the phosphor carrier with the phosphor paste, thereby forming a phosphor layer on the phosphor carrier.

6. The method according to claim 5, wherein the step of cleaning the transparent phosphor carrier comprises:
using organic solvent to carry out ultrasound or plasma cleaning to the phosphor carrier for 1 second to 10 hours;
using pure water or deionized water to carry out ultrasound cleaning to remove impurity on surface of the phosphor carrier.

7. The method according to claim 5, wherein the thickness of the phosphor layer is 0.1 micron to 10 mm, the value of the thickness is determined by intensity of blue light or violet light emitted by LED, mixture ratio of phosphor paste, and source light color temperature, and the art of thickness is controlled by screen number, mesh diameter, screen printing parameter and phosphor paste property.

8. The method according to claim 5, further comprises a step of molding the phosphor carrier to a desired shape, before the step of printing the phosphor paste, or after the step of hardening the phosphor paste.

9. The method according to claim 5, wherein the phosphor carrier is made of Acryl, PC, plastic, or glass material, the phosphor carrier is membraneous or slaty shape, and the phosphor carrier is 10 micron to 10 cm thick.

10. The method according to claim 5, wherein weight ratio of the LED phosphor and the transparent glue is 0.01:1 to 100:1, the transparent glue is kind of transparent liquid glue, and the transparent liquid glue is epoxy resins or silicone or silica gel or UV-curable resin.

11. The method according to claim 5, wherein the step of hardening the phosphor paste is carried out by illuminating the phosphor carrier by the ultraviolet hardening light, or baking the phosphor carrier under a predetermined temperature.
